(19) United States
(12) Patent Application Publication
(10) Pub. No.: US 2013/0219265 A1
(43) Pub. Date: Aug. 22, 2013

(54) Online Protocol Community

(71) Applicant: Srinivasa Nalabolu, San Diego, CA (US)

(72) Inventor: Srinivasa Nalabolu, San Diego, CA (US)

(73) Assignee: LIFE TECHNOLOGIES CORPORATION, Carlsbad, CA (US)

(21) Appl. No.: 13/812,453

(22) PCT Filed: Aug. 4, 2011
(86) PCT No.: PCT/US11/46649

§ 371 Date: May 1, 2013

Related U.S. Application Data
(60) Provisional application No. 61/371,622, filed on Aug. 6, 2010.

(51) Int. Cl. G06F 17/22

(52) U.S. Cl. CPC G06F 17/2247
USPC 715/234

(57) ABSTRACT

Provided herein is a computer-implemented method of personalizing a protocol in an online community of a plurality of users. The computer-implemented method includes providing a first protocol selected by a first user in the online community and receiving a request from the first user to modify the first protocol. The method further includes providing a set of editable fields to the first user for inputting a first modification, where the set of editable fields include a copy of dynamic content from the first protocol. The method includes generating a second protocol in response to the user inputting a first modification into one editable field of the set of editable fields, wherein the second protocol is based on the first protocol and includes the first modification.

### CROSS-REFERENCE TO RELATED APPLICATIONS

This application claims the benefit of priority of U.S. Provisional Application No. 61/371 622, filed Aug. 6, 2010, which is incorporated herein by reference in its entirety.

### FIELD

The present invention relates to online community websites.

### BACKGROUND

Protocols are a set of instructions that define a method or a process. Protocols are used by scientists and researchers to perform a series of steps to produce a result. Previously, protocols were written down in lab notebooks and published in scientific papers, and kept as a collection of hardcopy documents making sharing, collaboration, and organization challenging for scientists.

Currently, a tool for collaboration and dissemination of information is the Internet. The Internet has revolutionized communications and commerce as well as being a source of both information and entertainment. One type of website that has become more frequently used is that of an online community, also known as Wiki website. Online community websites are generated and maintained by a type of collaborative software on a server system. The online community provides a shared environment that may be accessed through an interface by a group of users.

An online community website application allows users to manipulate content displayed on the online community website. Users may add, remove, or otherwise edit and change content very quickly and easily. Online community website applications are often used as an effective tool for collaborative writing. The current use of online community website applications is directed towards collaborative content creation, such as online encyclopedias or other knowledge bases. Users typically can create content in a shared environment. In this environment, revisions of webpages are saved to allow previous versions to be restored. Further, mark-up shortcuts are provided for creating interpage links. Further, a “what you see is what you get” (WYSIWYG) editing mode/editor is often utilized.

### SUMMARY

Provided herein are methods and systems for modifying a protocol in an online community of a plurality of users.

According to various embodiments described herein, a computer-implemented method of personalizing a protocol in an online community of a plurality of users is provided. The computer-implemented method includes providing a first protocol selected by a first user in the online community and receiving a request from the first user to modify the first protocol. The method further includes providing a set of editable fields to the first user for inputting a first modification, where the set of editable fields include a copy of dynamic content from the first protocol. The method includes generating a second protocol in response to the user inputting a first modification into one editable field of the set of editable fields, wherein the second protocol is based on the first protocol and includes the first modification.

According to various embodiments, computer-readable medium encoded with instructions, executable by a processor, for personalizing a protocol in an online community is provided. The instructions include instructions for providing a first protocol selected by a first user in the online community and receiving a request from the first user to modify the first protocol. The instructions are further for providing a set of editable fields to the first user for inputting a first modification, where the set of editable fields include a copy of dynamic content from the first protocol. The instructions are further for generating a second protocol in response to the user inputting a first modification into one editable field of the set of editable fields, wherein the second protocol is based on the first protocol and includes the first modification.

According to various embodiments, a system for personalizing a protocol in an online community is provided. The system includes a processor and a memory storing instructions. The instructions include instructions for providing a first protocol selected by a first user in the online community and receiving a request from the first user to modify the first protocol. The instructions are further for providing a set of editable fields to the first user for inputting a first modification, where the set of editable fields include a copy of dynamic content from the first protocol. The instructions are further for generating a second protocol in response to the user inputting a first modification into one editable field of the set of editable fields, wherein the second protocol is based on the first protocol and includes the first modification.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented;

FIG. 2 is an exemplary distributed system configuration according to embodiments described herein;

FIG. 3 is a flowchart of a method according to embodiments described herein;

FIG. 4 is a representative view of online community home webpage according to embodiments described herein;

FIG. 5 is a representative view of a login webpage of an online community according to embodiments described herein;

FIG. 6 is a representative view of a online community webpage after login according to embodiments described herein;

FIG. 7 is a representative view of a webpage from an online community according to embodiments described herein;

FIG. 8 is a representative view of a webpage from an online community according to embodiments described herein;

FIG. 9 is a representative view of a webpage from an online community according to embodiments described herein;

FIGS. 10a-10c are representative views of a webpage from an online community according to embodiments described herein;

FIG. 11 is a representative view of a webpage from an online community according to embodiments described herein;

FIG. 12 is a representative view of a webpage from an online community according to embodiments described herein; and

FIG. 13 is a representative view of a webpage from an online community according to embodiments described herein.

### DETAILED DESCRIPTION

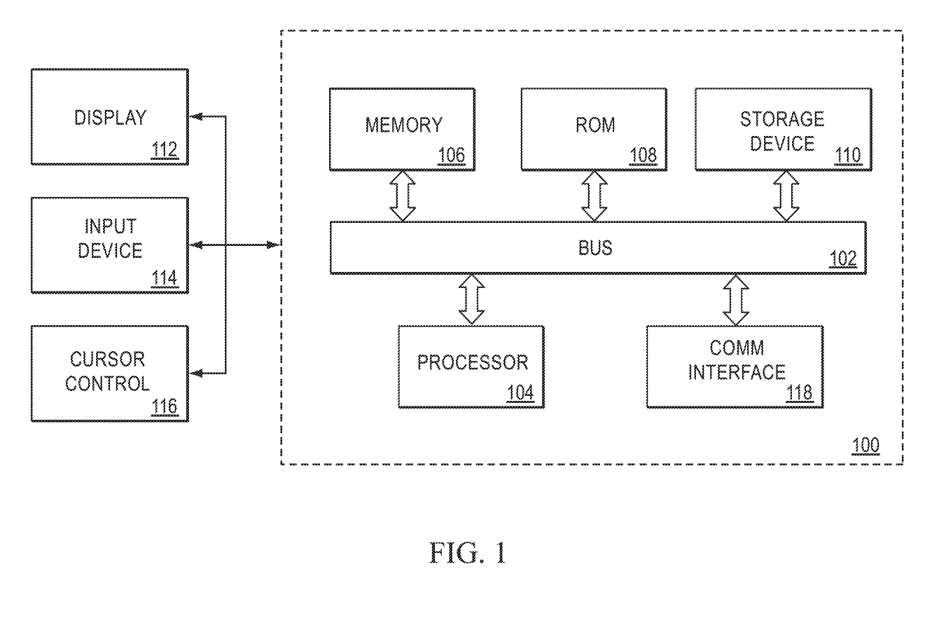

Provided herein is an online community, accessed by users over a network, such as the Internet. A Wiki is an example of such an online community, such as the Wiki described in U.S. Patent Application No. 20080010341, which is herein incorporated by reference. The online community provided to users may allow a user to search the online community for a protocol of interest. The online community may be a collection of webpages generated and stored by a computing system, or a distributed system, connected to a network. An exemplary computing system is described below with reference to FIG. 1. Users accessing the network can communicate with the computing system and access and participate in the online community. The user may be a user registered with the online community. In some embodiments, the user may be a guest user of the online community. The online community may further allow the user to copy or download a protocol from the online community. In some embodiments, the user may modify the protocol and then, optionally, save the protocol as a user-defined protocol. The user-defined protocol may be saved on the online community. In some embodiments the user-defined protocol may be downloaded or may be a print out of the protocol generated from the online community. In some embodiments, the user-defined protocol may: retain all downloadable files associated with the original protocol; retain all details of the original protocol; or retain all files and details of the original protocol. In some embodiments, the user-defined protocol may reference the original protocol by a link. In some embodiments the user-defined protocol may reference another user-defined protocol. In some embodiments, multiple user-defined protocols may reference other user-defined protocols. In some embodiments, the user defined protocols are searchable. The protocols may be searched according to various identifiers or parameter, including but not limited to name, reagent, protocol type, protocol length, target, product, or any other protocol parameter of interest. In some embodiments, the user-defined protocol may be a copy of an existing protocol.

Provided herein is a method of modifying a protocol comprising providing a first protocol from an online community to a user; and receiving a second protocol from the user, wherein the second protocol references the first protocol. The second protocol may be configured to be stored in memory, thus saving it to the online community.

Further provided herein is a method of personalizing a protocol from an online community comprising: receiving registration information from a user for registering in an online community; identifying a first protocol of interest; generating a second protocol; and saving the second protocol, wherein the second protocol is related to the first protocol. In some embodiments, the first protocol may comprise at least one detail which may be referenced by the second protocol. In some embodiments, the first protocol may comprise at least one linked file, which may be downloadable by users. The linked file may be included in the second protocol. The method may further comprise modifying the first protocol in the online community and, optionally, saving the modified protocol to the online community.

Yet another embodiment of the method provided herein includes a method of creating a modified protocol for an online community, the method comprising: searching for a protocol in an online community based on a user request; providing a copy of a selected protocol of interest; and receiving modifications to the protocol of interest and saving a second protocol including the modifications.

Also provided herein is a computer implemented method for creating a collaborative protocol, the computer implemented method comprising: providing a set of editable fields to be displayed to the user and used to manipulate a protocol, wherein the set of editable fields are configured to modify dynamic content of the protocol; and saving modifications based on user input in the editable fields.

Provided herein is an online community comprising at least one user; and at least one protocol, wherein the at least one protocol may be configured to be modified by the at least one user. In some embodiments the at least one user may be a registered user. In some embodiments, the at least one protocol may comprise at least one associated downloadable file. In some embodiments, the at least one protocol may comprise at least one detail. In some embodiments of the community, the online community may further comprise at least one modified protocol, wherein the at least one modified protocol is related to a protocol already available on the online community. In some embodiments, the at least one modified protocol is a copy of the at least protocol already available on the online community. In some embodiments, the at least one modified protocol may be available to the online community.

Further provided herein is an online community comprising at least one user; a first protocol comprising at least one element; and a second protocol comprising at least one element wherein the at least one element of the second protocol is the same as the least one element of the first protocol.

Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

FIG. 1 is a block diagram that illustrates a computer system 100 that may be employed to carry out processing functionality, according to various embodiments. Computing system 100 can include one or more processors, such as a processor 104. Processor 104 can be implemented using a general or special purpose processing engine such as, for example, a microprocessor, controller or other control logic. In this example, processor 104 is connected to a bus 102 or other communication medium.

Further, it should be appreciated that a computing system 100 of FIG. 1 may be embodied in any of a number of forms, such as a rack-mounted computer, mainframe, supercomputer, server, client, a desktop computer, a laptop computer, a tablet computer, hand-held computing device (e.g., PDA, cell phone, smart phone, palmtop, etc.), cluster grid, netbook, embedded systems, or any other type of special or general purpose computing device as may be desirable or appropriate for a given application or environment. Additionally, a computing system 100 can include a conventional network system including a client/server environment and one or more database servers, or integration with LIS/LIMS infrastructure. A number of conventional network systems, including a local area network (LAN) or a wide area network (WAN), and including wireless and/or wired components, are known in the art. Additionally, client/server environments, database servers, and networks are well documented in the art.

Computing system 100 may include bus 102 or other communication mechanism for communicating information, and processor 104 coupled with bus 102 for processing information.

Computing system 100 also includes a memory 106, which can be a random access memory (RAM) or other dynamic memory, coupled to bus 102 for storing instructions to be executed by processor 104. Memory 106 also may be used for storing temporary variables or other intermediate information during execution of instructions to be executed by processor 104. Computing system 100 further includes a read only memory (ROM) 108 or other static storage device coupled to bus 102 for storing static information and instructions for processor 104.

Computing system 100 may also include a storage device 110, such as a magnetic disk, optical disk, or solid state drive (SSD) is provided and coupled to bus 102 for storing information and instructions. Storage device 110 may include a media drive and a removable storage interface. A media drive may include a drive or other mechanism to support fixed or removable storage media, such as a hard disk drive, a floppy disk drive, a magnetic tape drive, an optical disk drive, a CD or DVD drive (R or RW), flash drive, or other removable or fixed media drive. As these examples illustrate, the storage media may include a computer-readable storage medium having stored therein particular computer software, instructions, or data.

In alternative embodiments, storage device 110 may include other similar instrumentalities for allowing computer programs or other instructions or data to be loaded into computing system 100. Such instrumentalities may include, for example, a removable storage unit and an interface, such as a program cartridge and cartridge interface, a removable memory (for example, a flash memory or other removable memory module) and memory slot, and other removable storage units and interfaces that allow software and data to be transferred from the storage device 110 to computing system 100.

Computing system 100 can also include a communications interface 118. Communications interface 118 can be used to allow software and data to be transferred between computing system 100 and external devices. Examples of communications interface 118 can include a modem, a network interface (such as an Ethernet or other NIC card), a communications port (such as for example, a USB port, a RS-232C serial port), a PCMCIA slot and card, Bluetooth, etc. Software and data transferred via communications interface 118 are in the form of signals which can be electronic, electromagnetic, optical or other signals capable of being received by communications interface 118. These signals may be transmitted and received by communications interface 118 via a channel such as a wireless medium, wire or cable, fiber optics, or other communications medium. Some examples of a channel include a phone line, a cellular phone link, an RF link, a network interface, a local or wide area network, and other communications channels.

Computing system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104, for example. An input device may also be a display, such as an LCD display, configured with touchscreen input capabilities. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. A computing system 100 provides data processing and provides a level of confidence for such data. Consistent with certain implementations of embodiments of the present teachings, data processing and confidence values are provided by computing system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process states described herein. Alternatively hard-wired circuitry may be used in place of or in combination with software instructions to implement embodiments of the present teachings. Thus implementations of embodiments of the present teachings are not limited to any specific combination of hardware circuitry and software.

The term “computer-readable medium” and “computer program product” as used herein generally refers to any media that is involved in providing one or more sequences or one or more instructions to processor 104 for execution. Such instructions, generally referred to as “computer program code” (which may be grouped in the form of computer programs or other groupings), when executed, enable the computing system 100 to perform features or functions of embodiments of the present invention. These and other forms of computer-readable media may take many forms, including but not limited to, non-volatile media, volatile media, and transmission media. Non-volatile media includes, for example, solid state, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on magnetic disk of a remote computer. The remote computer can load the instructions into its dynamic memory and send the instructions over a telephone line using a modem. A modem local to computing system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

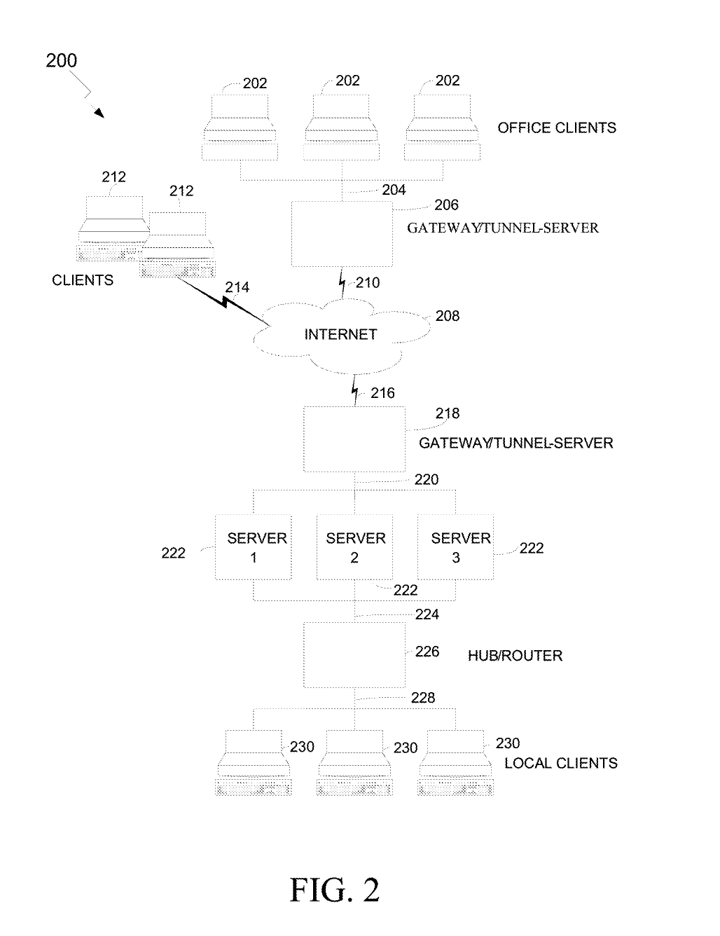

Some of the elements of a typical Internet network configuration 200 are shown in FIG. 2, wherein a number of client machines 202 possibly in a remote local office, are shown connected to a gateway/hub/tunnel-server/etc. 210 which is itself connected to the internet 208 via some internet service provider (ISP) connection 210. Also shown are other possible clients 212 similarly connected to the internet 208 via an ISP connection 214, with these units communicating to possibly a central lab or office, for example, via an ISP connection 216 to a gateway/tunnel-server 218 which is connected 220 to various enterprise application servers 222 which could be connected through another hub/router 226 to various local clients 230. Any of these servers 222 could function as a development server for the analysis of potential content management and delivery design solutions as described in the present invention, as more fully described below.

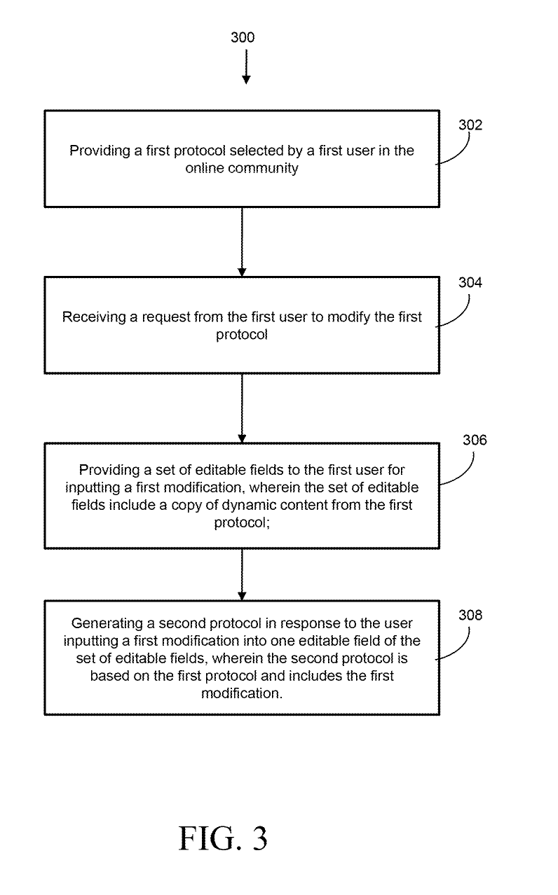

FIG. 3 is a flowchart illustrating an exemplary method 300 of protocol collaboration according to embodiments described herein. In step 302, a processor of a computing system 100, for example, provides a first user in an online community a first protocol. The protocol may be selected from search results provided to the user. The search results may be generated by search terms input by the user in some embodiments. In other various embodiments, the user may be presented with dynamically generated search results based on an aspect of the user's profile information input by the user during registration to the online community, or the user's browsing history, for example. The processor may provide users data over a network, like the Internet, as described above. A request from the first user to modify the first protocol is received by the processor in step 304. In response, the user is provided with a set of editable fields to the first user for inputting a first modification in step 306. The set of editable fields may include a copy of dynamic content from the first protocol. Dynamic content may include the text of the protocol, for example. In step 308, the second protocol is generated in response to the user inputting a first modification into one editable field of the set of editable fields. As such, the second protocol is based on the first protocol and includes the first modification. The second protocol is stored and the first user is associated with the second protocol as the author. According to various embodiments, the author may be the only user of the online community or of any user viewing the second protocol allowed to delete the second protocol. The author may also be the only user with permissions to overwrite the second protocol according to various embodiments.

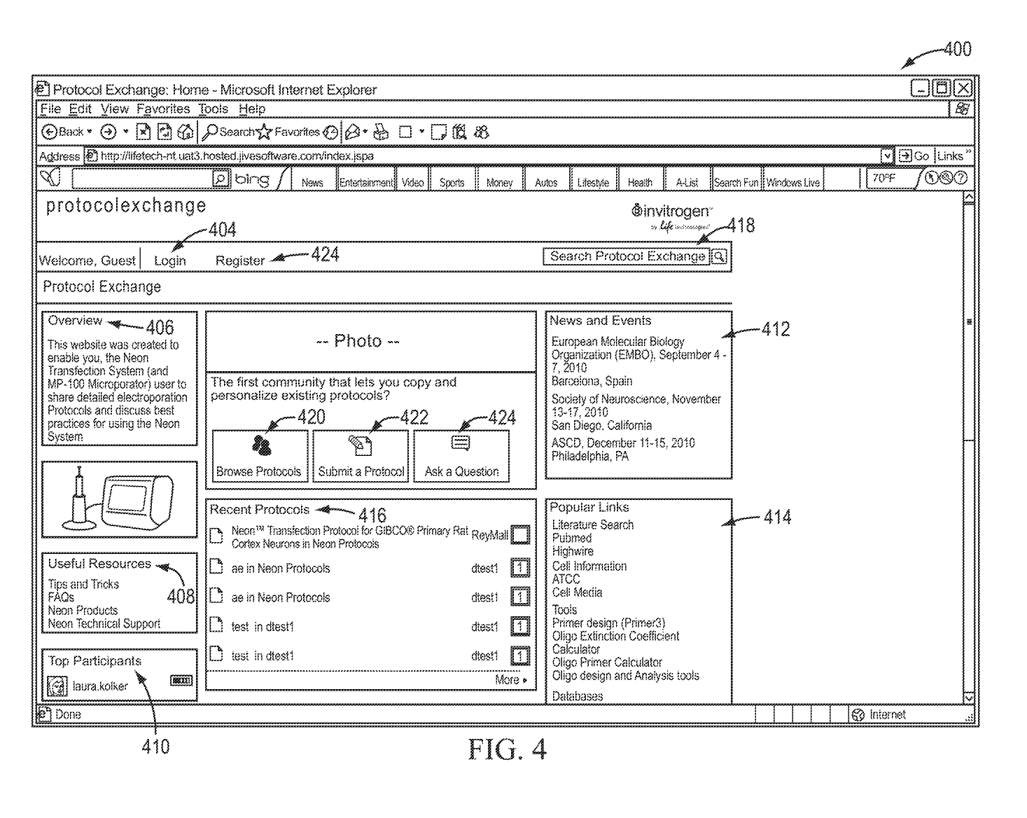

FIG. 4 shows an example of an online community web-based homepage 400 that may be provided to the users of the online community from the system. The homepage 400 may include a link to register 402 with the online community. Additionally, the homepage 400 may include a login link 404 to the home page if the user has already previously registered with the online community. In some embodiments, the user may login using a guest login link. If the user has not previously registered, the user may be provided with a display to enter in registration information to submit to the online community system. The registration information may include, but is not limited to, name, address, company/organization affiliation, interests, position. This information may be used to further customize the information provided to the user, including news, relevant products, and tips and tricks, for example.

The various links described herein refer to a dynamic link between different webpages or other information that a user may select. The link may include an address to a particular webpage, for example. In response to the user's request for the webpage or information referenced in the link, the online community system provides the referenced webpage or information for display to the user. These webpages may be part of the online community, but may also be webpages from outside the online community.

Additional features may be visible to a user on the online community homepage 400 prior to registering and logging in to the online community. In some embodiments, an overview 406 of the online community may be available. The overview 406 may serve to provide information to the user including, but not limited to, introducing the user to the online community. The homepage 400 may include useful resources 408 including, but not limited to, tips and tricks for navigating the online community and/or for using any relevant products, frequently asked questions about the online community and/or any relevant products, products being used by the online community, and/or technical support. The online community homepage 400 may show a list of top participants 410 of the online community. The list of top participants may include an active link to electronically communicate with the participant listed.

Other features that may be visible to a user on the online community homepage 400 may include a listing of news and events 412. The news and events may be limited to products associated with the online community. Alternatively, the listing of news and events 412 may include any information related to the technology area of the online community, including but not limited to scientific meetings, journal articles, company press releases, sponsored events, guest lecturer series, and any other suitable news or events. In some embodiments, the listing of news and events 412 may include active links to websites not sponsored by the online community. In some embodiments, a listing of popular links 414 may be available on the online community homepage 400. In some embodiments, the listing of popular links may include technical information including, but not limited to literature search engines, journal articles, cell information, such as ATCC and cell media information, tools, such as primer design, oligo extinction coefficient calculator, oligo primer calculator, oligo design and analysis tools, databases, or any other suitable popular link.

Yet other features that may be available on an online community homepage 400 include a listing of recent protocols 416. In some embodiments, the listing of recent protocols 416 may be a listing of the protocols that have the highest viewing by other viewers or users. In some embodiments, the listing of recent protocols 416 may be a listing of the protocols that have most copies and/or modified by viewers. In some embodiments, the listing of recent protocols 416 may be a listing of the most recently modified protocol that have been saved to the online community. In some embodiments, a search box 418 may be available on the online community home page. The search box 418 may be used to search only the online community or alternatively, the search box 418 may be used to search the entire world-wide web or a subset thereof.

In some embodiments the online community homepage 400 may include additional links, such as, for example purposes only, a link for browsing 420 a listing of protocols available in the online community, a link for submitting a protocol 422 to the online community, and a link for asking questions 424 related to any of the protocols in the online community. In some embodiments, all the links on the homepage 400 are active prior to logging into the online community. Alternatively, only some links on the homepage 400 may be active prior to logging into the online community. In some embodiments, none of the links on the homepage 400 are available prior to logging into the online community.

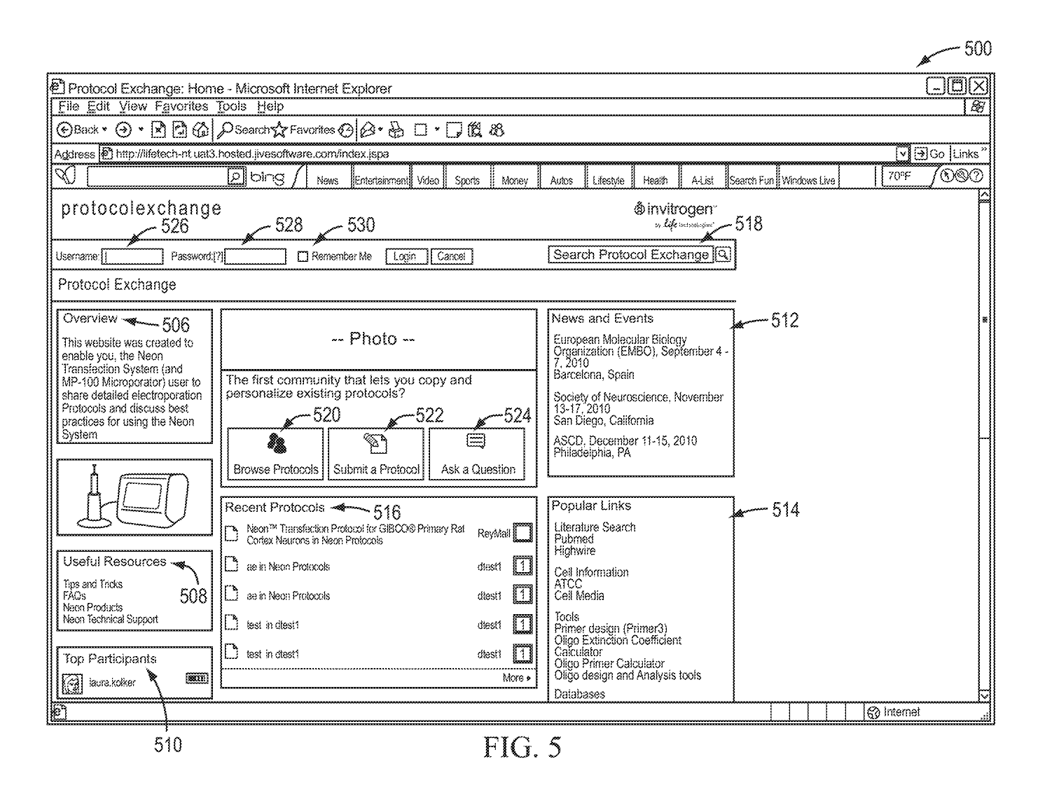

FIG. 5 shows an example of a login page 500 for an online community. A registered user may log into the online community by entering a username in a username field 526 and a password in a password field 528. In some embodiments, the username may be a chosen by the user or alternatively the username may be assigned by the online community website. In some embodiments, the user may be initially assigned a password by the online community website. In some embodiments the user may change the username and/or password after logging into the online community a first time. In some embodiments, the login webpage 500 may allow the user to indicate whether the online community should remember the user. In some embodiments, the user may check a “remember me” box 530 to indicate the user wishes to be remembered, eliminating the need to repeatedly login to the online community for a certain period of time.

Additionally, other features may still be visible to the user on the login page 500 as previously described above. Such features include, but are not limited to an overview 506 of the online community, useful resources 508, top participants 510, news and events listings 512, popular links 514, recent protocols 516, search box 518, a link for browsing 520 a listing of protocols available in the online community, a link for submitting a protocol 522 to the online community, and a link for asking questions 524 related to any of the protocols in the online community. In some embodiments, all the links on the login page 500 are active prior to logging into the online community. Alternatively, only some links on the login page 500 may be active prior to logging into the online community. In some embodiments, none of the links on the login page 500 are available prior to logging into the online community.

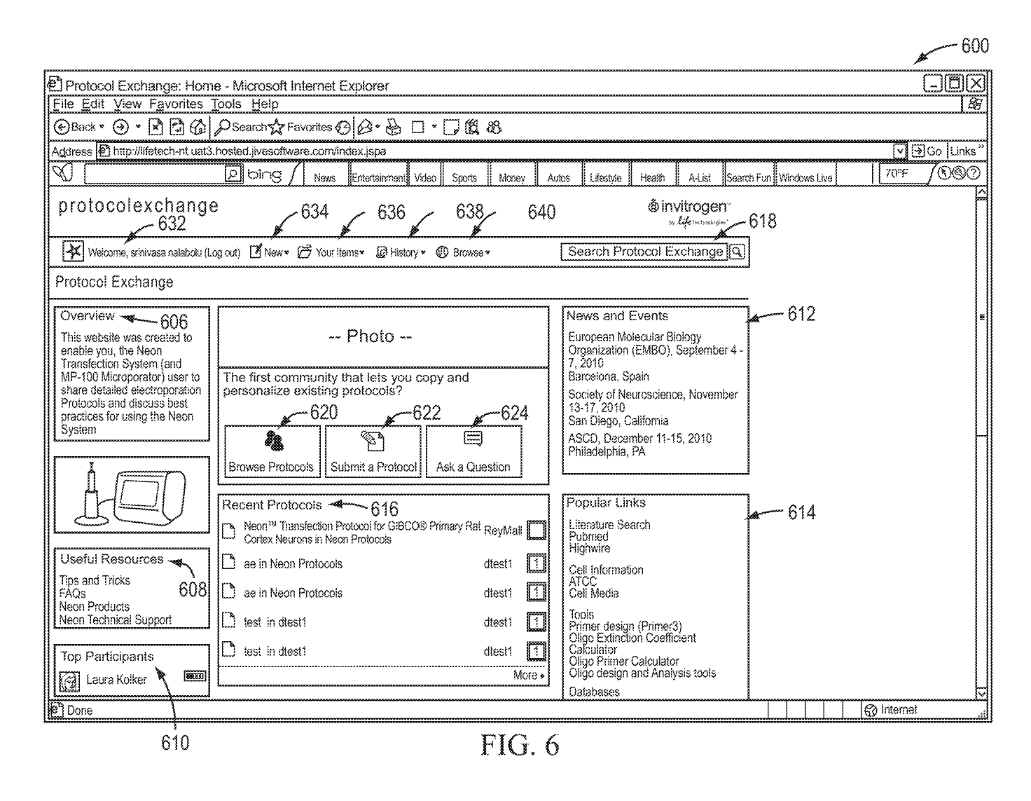

FIG. 6 shows a representative example of an online community webpage 600 after a registered user has logged into the online community. After a user logs into an online community, the user may be identified by a welcome message 632. Additional features may also become available to a registered user after logging into the website. In some embodiments, a new item link 634 may be present on the website 600. The new item link 634 may provide for a link to creating new protocols that are originally created on the online community or for creating user-defined protocols that are modifications of protocols already posted on the online community. In some embodiments, a user items link 636 may be present on the website 600. The user items link 636 may provide a link to protocols identified by the user. These protocols may be relevant protocols, user-defined protocols created by the user, copied protocols, saved protocols, communications between users in the online community, saved websites, groups, spaces, bookmarks, discussions, documents, videos, profile, preferences, friends, messages, notifications specific to the user, for example, invitations to join a group, or any other suitable item identified by a user. Additionally, a history link 638 may be available for tracking the user through the online community. In some embodiments, the history link 638 may assist the user in finding a product, website, protocol, or any other suitable item previously visited by the user. In some embodiments, a browse link 640 may be available. The browse link may allow the user to browse through different sections or categories of the online community including blog posts, bookmarks, discussions, documents, protocols, videos, tags, communities, groups, people, or any other suitable category.

Additionally, other features may still be visible to the user on the webpage 600 as previously described above. Such features include, but are not limited to an overview 606 of the online community, useful resources 608, top participants 610, news and events listings 612, popular links 614, recent protocols 616, search box 618, a link for browsing 620 a listing of protocols available in the online community, a link for submitting a protocol 622 to the online community, and a link for asking questions 624 related to any of the protocols in the online community.

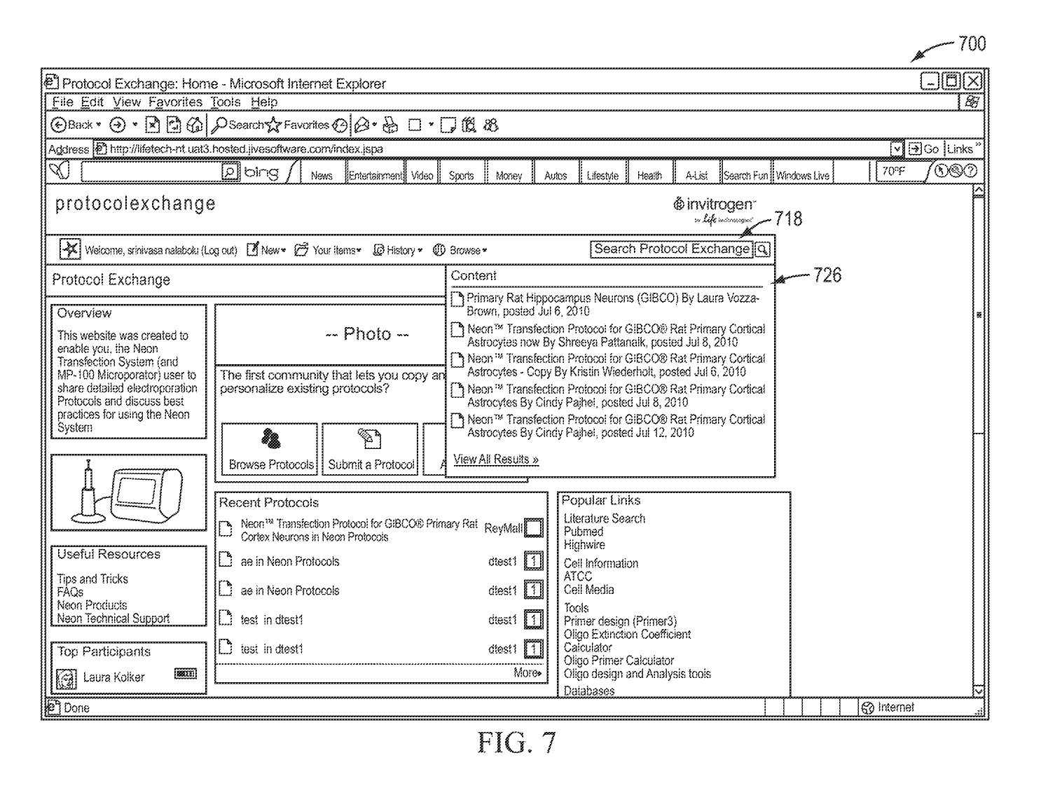

FIG. 7 shows a representative example of an online community webpage 700 where the user is conducting a search of the online community. In some embodiments, the user may conduct a search using the search box 718 by inputting a search term. In some embodiments, the search term may be a keyword. The search term may be a cell name, product, reagent, username, protocol, or any other suitable search term. After the user inputs a search term, a list of relevant items 726 may be generated. In some embodiments, the relevant items list may be generated in real-time. As the user types in more letters of the search term, the relevant item list may be modified in real-time to correspond to the search term. In some embodiments, the relevant item list is generated after the user indicates the search should be conducted. In some embodiments, all relevant items are listed in the relevant item list. Alternatively, only some items are listed in the relevant item list such as, for example purposes only, the top five most popular links. In some embodiments, a link may be provided to take the user to the complete list of relevant items.

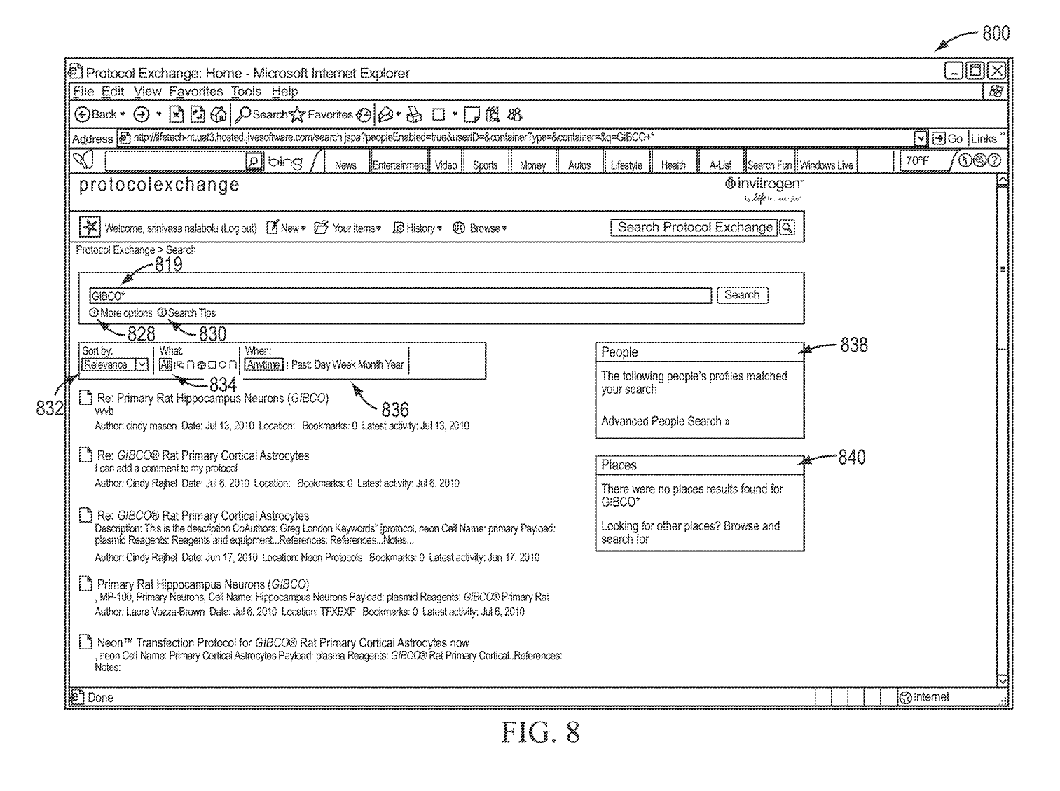

FIG. 8 shows a representative example of the search results webpage 800 of an online community. The search term is displayed in a secondary search box 819. In some embodiments, the user may add or remove terms from the secondary search box to further refine the search. Additionally, the search result webpage 800 may include an options link 828 and/or a search tips link 830. The options link 828 may allow the user to identify further parameters for conducting the search including for example additional search terms, specific products to be used, favorite protocols of specific users or institution, or any other suitable search parameter. The search tips link 830 may provide the user with suggested search language, help in narrowing the search, identify other products that are related to any keywords entered or may provide for any other suitable search tip.

The search results webpage 800 provided from the online community system may provide the user with a list of all protocols corresponding to the search terms. In some embodiments, a sorting feature 832 may be present to sort the protocols by any suitable feature including but not limited to relevance, time, popularity, user-identified favorite, or any other suitable feature. Additionally, the search results may be further categorized according to type using a type of result sorter 834. The results may be categorized into types including, but not limited to, discussions, documents, spaces, videos, protocol, or any other suitable category relevant to the online community. In some embodiments the results may be categorized by date entered in the online community using a date entered sorter 836.

Additional features may be available on the search result website including a people identifier 838 which may identify other registered users corresponding to the search terms and/or place identifier 840 which may identify places found corresponding to the search terms.

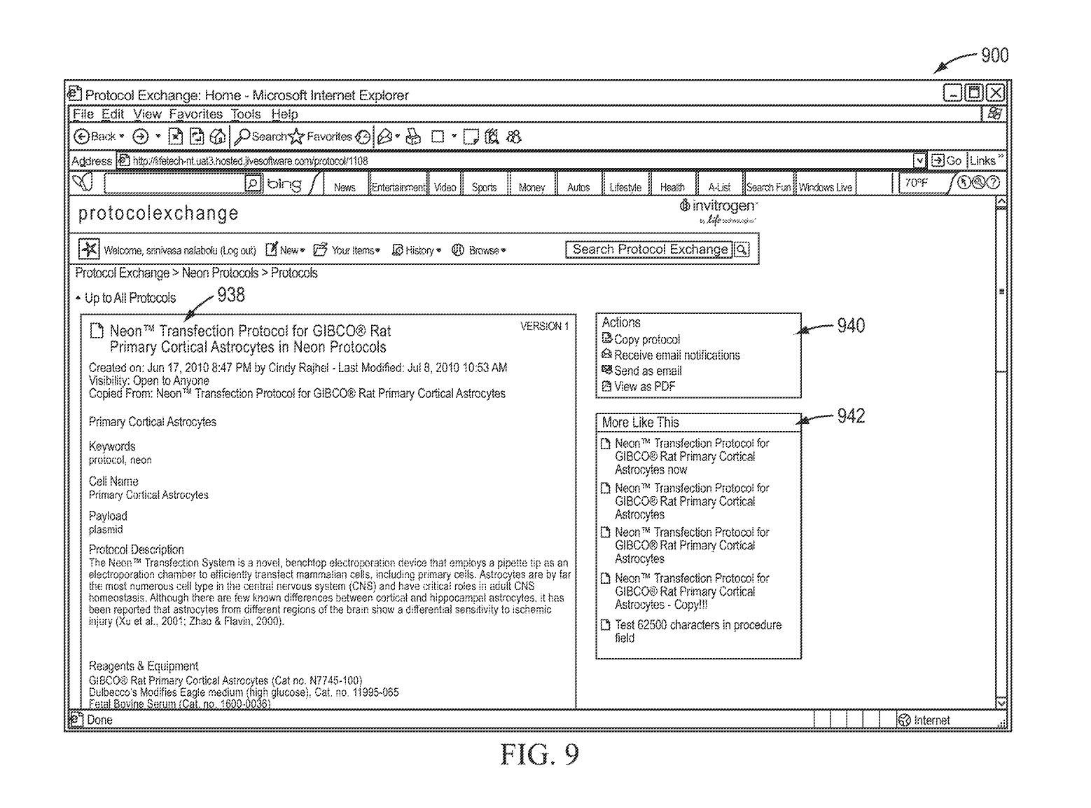

Once the search results are generated a user may identify a protocol of interest. The user may then open the protocol of interest by activating a link on the search result webpage corresponding to that protocol. FIG. 9 shows a representative example of a protocol viewed from a webpage 900 opened from the search results. The protocol may be identified by a protocol identifier 938. Additional information about the protocol may be made available on the webpage 900 including, but not limited to, keywords associated with the protocol, cell names associated with the protocol, payload, protocol description, reagents, equipment, instruments, or any other suitable information related to the protocol.

In some embodiments additional related items may be identified to the user in a related items list 942. The related items may include other protocols, discussions, documents, videos, messages, or any other suitable related item. Additionally, an action listing 940 may be present on the webpage 900. The actions may include, but are not limited to, copying the protocol, requesting email notifications about the protocol including changes made to the protocol, emailing the selected protocol, or viewing the protocol in a printable format, such as a PDF file.

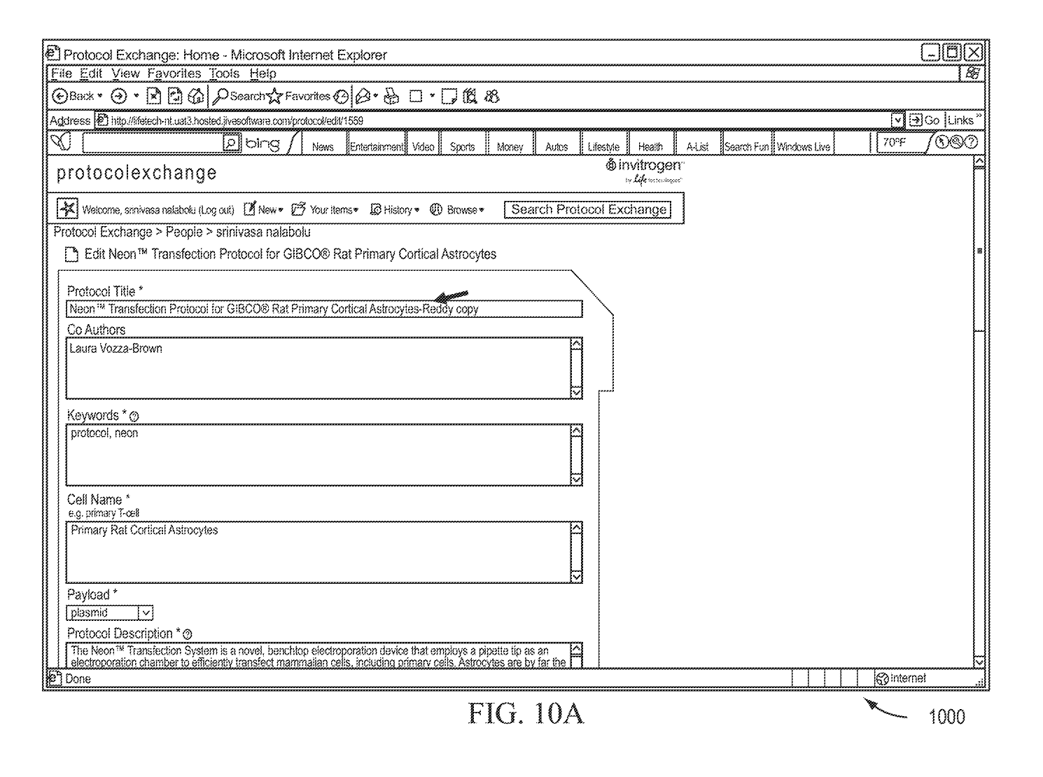

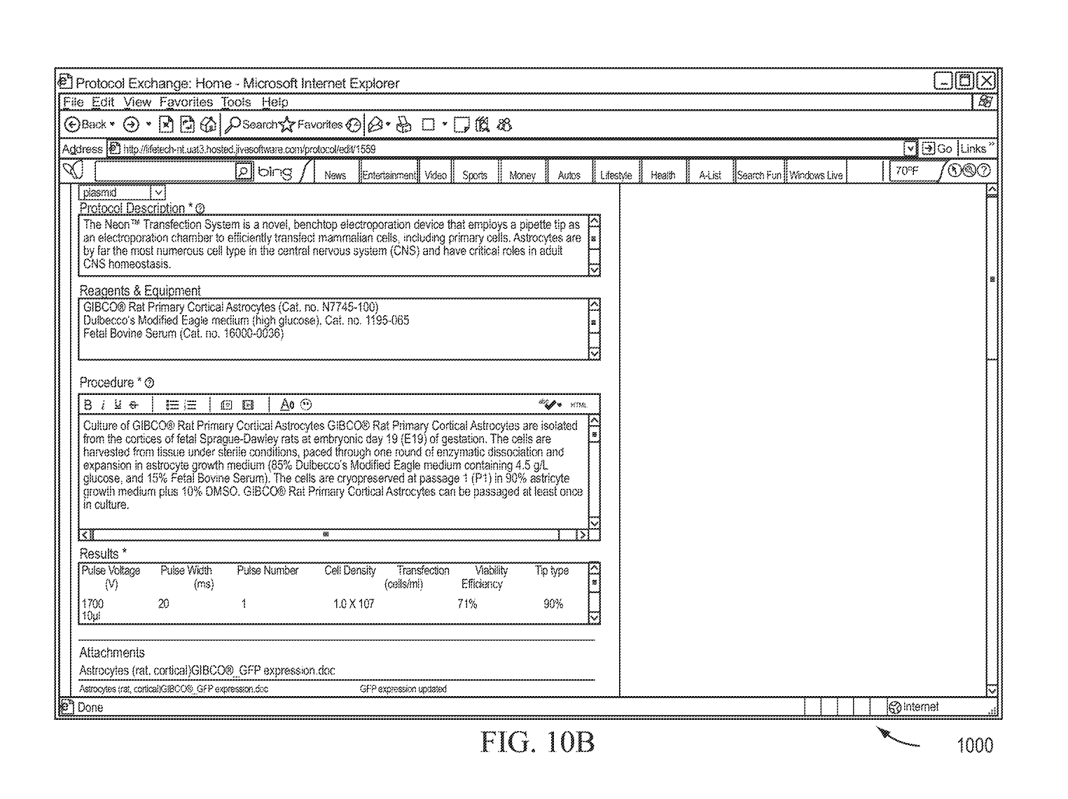

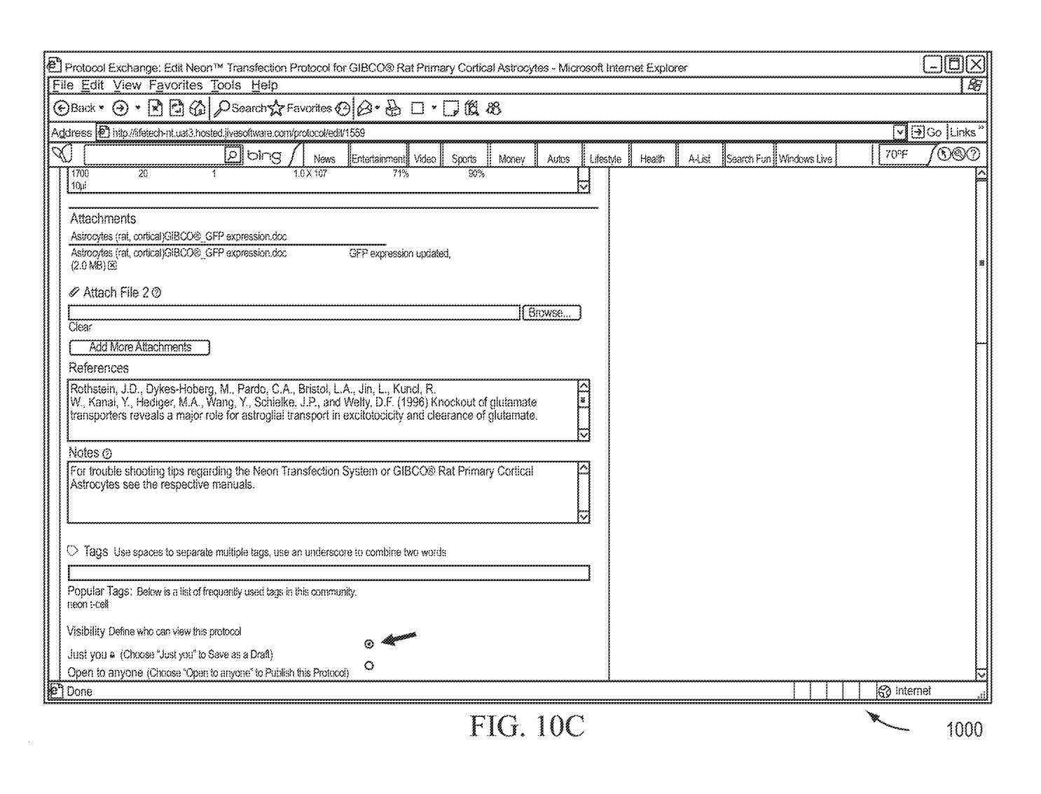

Once the user has identified a protocol of interest, the user may then copy the protocol. FIGS. 10a-10c show a protocol open for editing by the user. Dynamic content of the protocol may be copied into the various editable fields. Dynamic content such as the text for materials, title, process, among other things, are copied and provided to the user in the editable fields. Various parameters of the protocol may be edited including, but not limited to, title, authorship, keywords or identifiers, cell names, payload, protocol description, reagents, equipment, the procedure, results, references, notes, tags associated with the protocols. Additionally, in some embodiments files may be attached to the protocol. The attached files may be downloadable by the user viewing the protocol. The user may save the protocol as a draft so that the protocol may only be viewable by the user. Alternatively, the user may make the protocol available publicly by publishing the protocol to the online community.

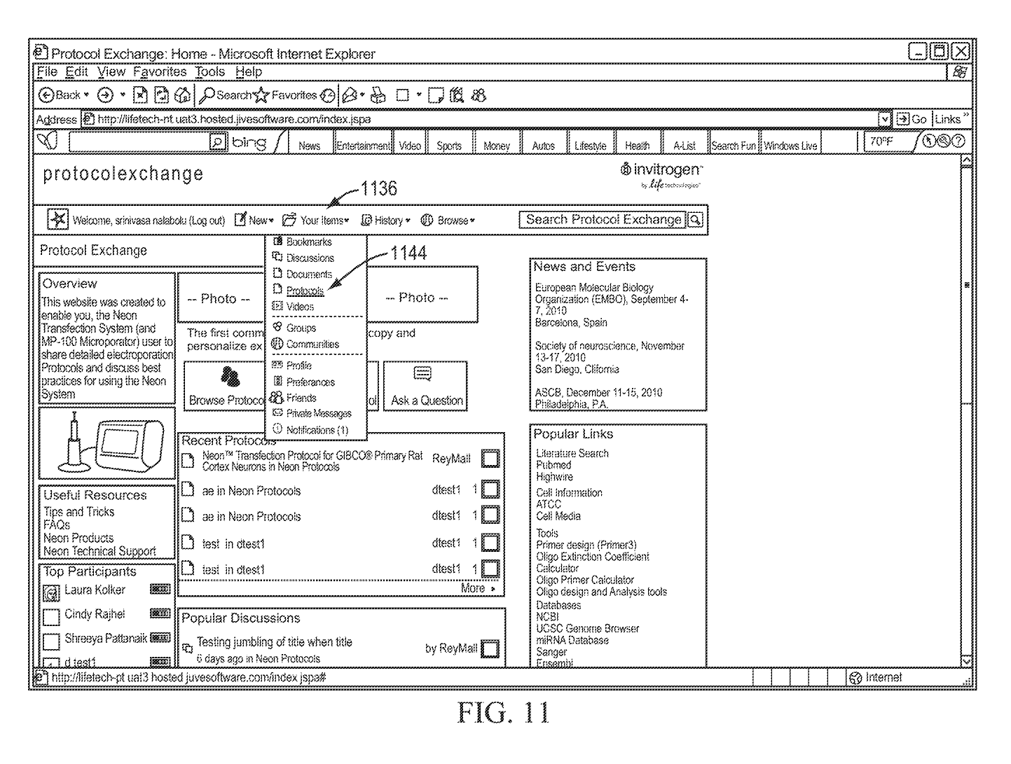

FIG. 11 shows a representative example of a webpage 1100 after the user has logged in. Copied protocols may be located in a designated space in the online community, for example, in the protocol link 1144 under the user items link 1136.

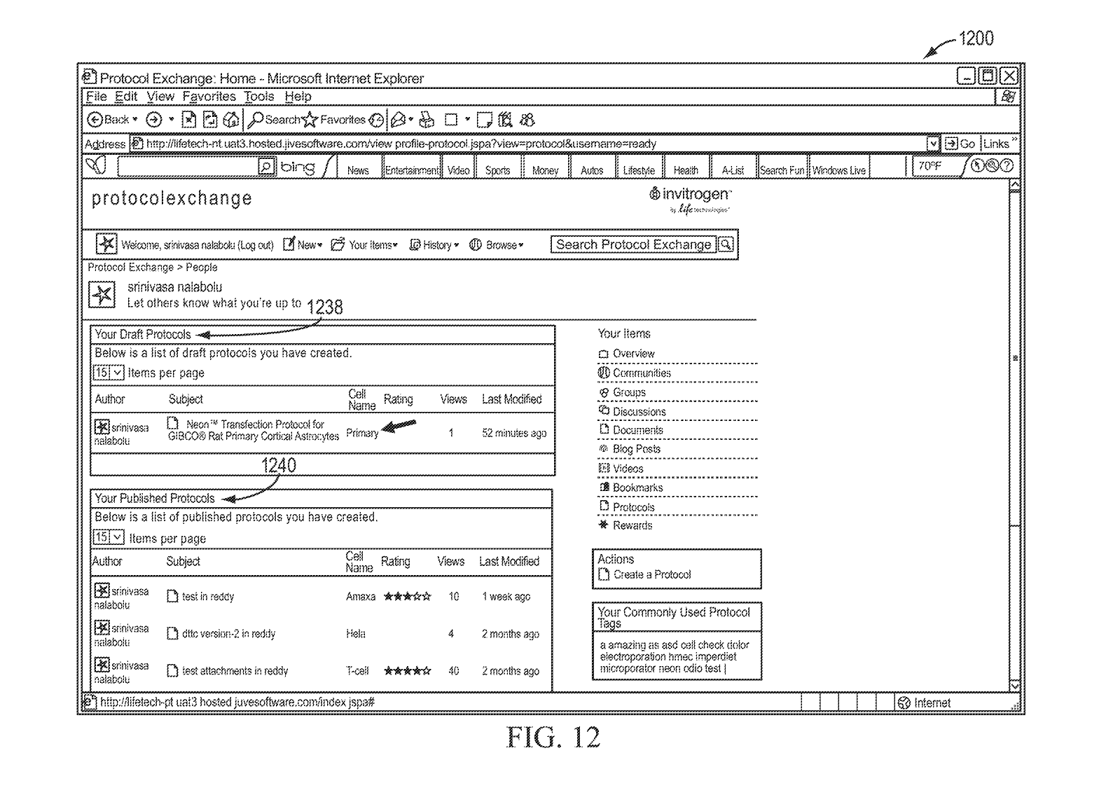

FIG. 12 shows a representative protocol webpage 1200 of specific to a user. The protocol webpage 1200 may provide a draft protocol list 1238 which indicate protocols currently being drafted or modified by the user. Additionally, the protocol webpage 1200 may provide a published protocol list 1240 which indicates protocols published or made public to the online community. The published protocol list 1240 may provide additional information including, but not limited to, the number of times the published protocol was viewed, peer rating of the protocol, the last time the protocol was modified and any other suitable information relating to the published protocol.

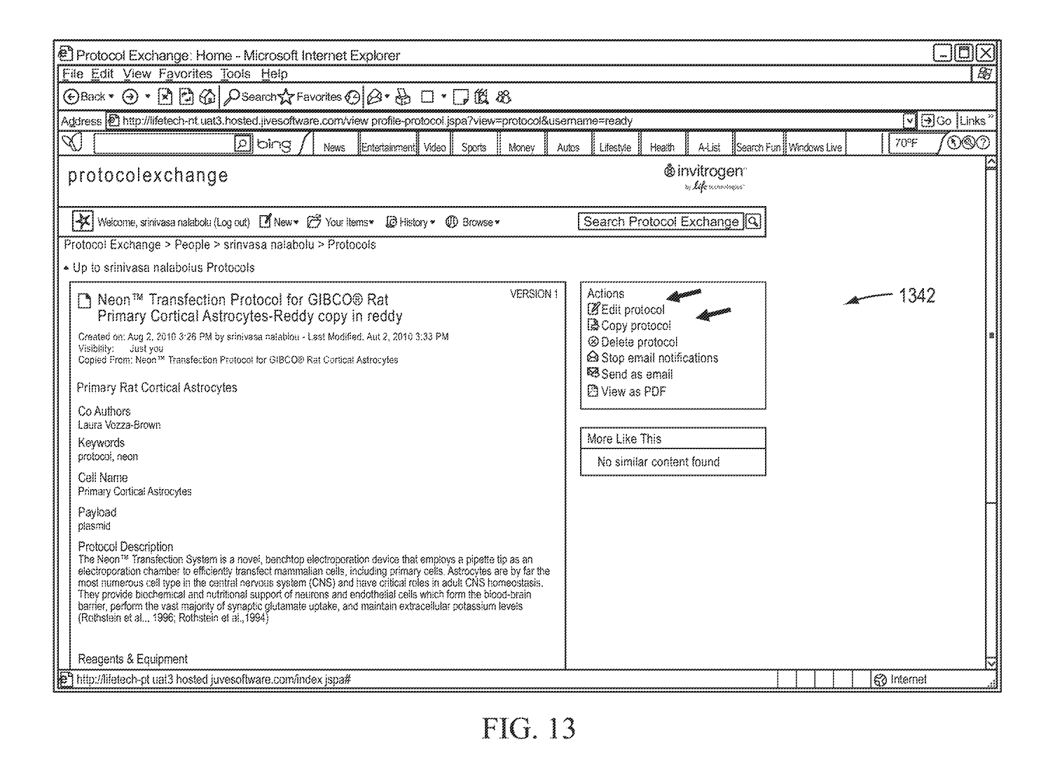

Once a protocol is selected from either the draft protocol list or the published protocol list, the protocol may then be modified again by the user. The protocol selected may be edited by the user or, alternatively, the protocol selected may be copied and used to generate a new user-defined protocol. FIG. 13 shows a representative example of a webpage 1300 showing a selected protocol from the user's identified protocols. In some embodiments, additional actions may be available. These additional actions may be identified in an action list 1342 and may include, but are not limited to, editing the protocol, deleting the protocol, copying the protocol, stop email notifications about the protocol, including changes made to the protocol or copies of the protocol made, emailing the protocol, viewing the protocol in a printable file, such as a PDF.

Further provided herein is a method of creating a protocol using a copy protocol feature. In some embodiments of the method, the method provides for the following: searching for a protocol from an online community, selecting a protocol of interest from the search results, opening the selected protocol, copying the selected protocol, and modifying the protocol. In some embodiments, the user may search for a protocol depending on keyword, cell name, or any other suitable search parameter. In some embodiments, the user may rename the protocol to a user-identifiable protocol. In some embodiments, the protocol is saved in the user specific items section. In some embodiments, the user may publish the protocol.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A computer-implemented method of personalizing a protocol from an online community of a plurality of users, the computer-implemented method comprising:
providing a first protocol selected by a first user in the online community;
receiving a request from the first user to modify the first protocol;
providing a set of editable fields to the first user for inputting a first modification, wherein the set of editable fields include a copy of dynamic content from the first protocol; and
generating a second protocol in response to the user inputting a first modification into one editable field of the set of editable fields, wherein the second protocol is based on the first protocol and includes the first modification.

2. The computer-implemented method of claim 1, further comprising:
storing the second protocol, wherein the second protocol is associated with the first user.

3. The computer-implemented method of claim 2, wherein modifications to the second protocol are dynamically stored in response to an input by the user into any one of the editable fields.

4. The computer-implemented method of claim 2, wherein the second protocol is restricted from being deleted by another user in the online community.

5. The computer-implemented method of claim 1, further comprising:
providing the second protocol to a second user in the online community;
receiving a second modification related to the second protocol from the second user; and
storing a third protocol based on the second protocol and including the second modification.

6. The computer-implemented method of claim 1, wherein the second protocol is configured to be provided, upon the storing of the second protocol, to any user of the plurality of users in response to a request of the second protocol by a user.

7. The computer-implemented method of claim 1, wherein the second protocol is configured to be provided, upon the storing of the second protocol, to a determined set of users of the plurality of users in response to a request of the second protocol by a user.

8. The computer-implemented method of claim 1, wherein the second protocol comprises at least one detail of the first protocol.

9. The computer-implemented method of claim 1, wherein the first protocol is related to a file downloadable by the first user provided with the first protocol.

10. The computer-implemented method of claim 9, wherein the file is downloadable by a user provided with the second protocol.

11. The computer-implemented method of claim 1, further comprising:
registering the first user in the online community.

12. A computer-readable medium encoded with instructions, executable by a processor, the instructions comprising instructions for:
providing a first protocol selected by a first user in the online community;
receiving a request from the first user to modify the first protocol;
providing a set of editable fields to the first user for inputting a first modification, wherein the set of editable fields include a copy of dynamic content from the first protocol; and
generating a second protocol in response to the user inputting a first modification into one editable field of the set of editable fields, wherein the second protocol is based on the first protocol and includes the first modification.

13. The computer-readable medium of claim 12, wherein the instructions further comprise instructions for:
storing the second protocol, wherein the second protocol is associated with the first user.

14. The computer-readable medium of claim 13, wherein modifications to the second protocol are dynamically stored in response to an input by the user into any one of the editable fields.

15. The computer-readable medium of claim 12, wherein the second protocol is restricted from being deleted by another user in the online community.

16. The computer-readable medium of claim 12, wherein the instructions further comprise instructions for: providing the second protocol, upon the storing of the second protocol, to any user of the plurality of users in response to a request of the second protocol by a user.

17. The computer-readable medium of claim 12, wherein the instructions further comprise instructions for: providing the second protocol, upon the storing of the second protocol, to a determined set of users of the plurality of users in response to a request of the second protocol by a user.

18. A system for personalizing a protocol from an online community of a plurality of users, the system comprising:
a processor; and
a memory for storing instructions executable by the processor, the instructions comprising instructions for:
providing a first protocol selected by a first user in the online community;
receiving a request from the first user to modify the first protocol;
providing a set of editable fields to the first user for inputting a first modification, wherein the set of editable fields include a copy of dynamic content from the first protocol; and
generating a second protocol in response to the user inputting a first modification into one editable field of the set of editable fields, wherein the second protocol is based on the first protocol and includes the first modification.

19. The system of claim 18, wherein the instructions further comprise instructions for:
storing the second protocol, wherein the second protocol is associated with the first user.

20. The system of claim 18, wherein the instructions further comprise instructions for:
providing the second protocol to a second user in the online community;
receiving a second modification related to the second protocol from the second user; and
storing a third protocol based on the second protocol and including the second modification.
